(19) United States
(12) Patent Application Publication
(10) Pub. No.: US 2016/0187669 A1
(43) Pub. Date: Jun. 30, 2016

(54) IMAGE BLUR CORRECTION APPARATUS, IMAGE PICKUP APPARATUS AND OPTICAL APPARATUS

(71) Applicant: CANON KABUSHIKI KAISHA, Tokyo (JP)

(72) Inventor: Nobuyoshi Suzuki, Tokyo (JP)

(21) Appl. No.: 14/968,288

(22) Filed: Dec. 14, 2015

(30) Foreign Application Priority Data
Dec. 24, 2014 (JP) 2014-260451

(51) Int. Cl. G02B 27/64; G02B 7/02; H04N 5/232; G03B 5/00

(52) U.S. Cl. CPC G02B 27/646; G03B 5/00; G02B 7/026; H04N 5/23264

(57) ABSTRACT

An image blur correction apparatus includes a base plate member, a holding member that holds an image blur correction lens, an even number of actuator constituting members for moving the holding member, a support member arranged in such a manner that the holding member is movable relative to the base plate member, and a plurality of bias members performing biasing in such a manner that the support member is sandwiched by the base plate member and the holding member, wherein at least one of the bias members is arranged in a region between two of the actuator constituting members, and wherein the bias members arranged in two regions each between two of the actuator constituting members, the two regions opposing each other through a gravity center of the holding member.

### BACKGROUND OF THE INVENTION

1. Field of the Invention

The present invention relates to an image blur correction apparatus, an image pickup apparatus and an optical apparatus, and specifically to what are suitable for use in correcting image blurring.

2. Description of the Related Art

Conventionally, for correcting image blurring caused by hand shaking that easily occurs in handheld photography and the like, there have been known image blur correction apparatuses (optical image stabilizing units) that eliminate image blurring by shifting an image blur correction lens in a plane perpendicular to an optical axis.

As such optical apparatuses described above, there have been known apparatuses that shift a correction lens in a first direction or a second direction (perpendicular to the first direction) without rotating the correction lens around an optical axis.

Japanese Patent Application Laid-Open No. 2013-125228 discloses a following technique. Namely, three balls are arranged between a lens holder for holding an image blur correction lens and a base member. Those three balls are sandwiched between the lens holder and the base member by the three springs that are respectively arranged outside those three balls. With this configuration, the lens holder is moved in a plane perpendicular to the optical axis.

However, in the hooking manner of the three springs as disclosed in Japanese Patent Application Laid-Open No. 2013-125228, a position of a gravity center of the lens holder is positioned far from a point where spring forces of the three springs are combined. Accordingly, it might occur that a balance of forces collapses, a part of the lens holder is lifted up and a mechanism itself does not function.

The invention has been made in view of such problems and is intended to provide a configuration capable of holding stably a lens for image blur correction.

### SUMMARY OF THE INVENTION

An image blur correction apparatus of the invention comprises: a base plate member; a holding member that holds an image blur correction lens; an even number of actuator constituting members, mounted on the holding member for moving the holding member; a support member arranged in a region between the base plate member and the holding member to support the holding member in such a manner that the holding member is movable relative to the base plate member in a plane orthogonal to an optical axis of an optical system excluding the image blur correction lens; and a plurality of bias members, one end and the other end thereof being respectively mounted on the holding member and the base plate member, the bias members performing biasing in such a manner that the support member is sandwiched by the base plate member and the holding member, wherein at least one of the bias members is arranged in a region between two of the actuator constituting members adjacent to each other in the circumferential direction of the holding member, and wherein the bias members arranged in two regions each between two of the actuator constituting members adjacent to each other in the circumferential direction are the same in number, the two regions opposing each other through a gravity center of the holding member.

Further features of the present invention will become apparent from the following description of exemplary embodiments with reference to the attached drawings.

### BRIEF DESCRIPTION OF THE DRAWINGS

FIG. 1 is a view illustrating a configuration of an image pickup apparatus.

FIG. 2 is a view illustrating a configuration of a lens barrel.

FIG. 3 is a view (an exploded perspective view) illustrating a configuration of a second group barrel.

FIG. 4 is a view (a front view) illustrating a configuration of a second group barrel.

FIG. 5 is a view (a rear view) illustrating a configuration of the second group barrel.

FIG. 6A is a view explaining a positional relation between a ball and a spring.

FIG. 6B is an enlarged view illustrating a portion D1 of FIG. 6A.

FIG. 7A is a view illustrating a force acting on a second group holding frame in an X axis direction.

FIG. 7B is an enlarged view illustrating a portion D2 of FIG. 7A.

FIG. 8 is a view illustrating a holding frame and a base plate of a generally image blur correction apparatus.

FIG. 9 is a view illustrating a force acting on the holding member illustrated in FIG. 8 in an X axis direction.

FIG. 10 is a view illustrating a force acting on a hook stop portion of a second group holding frame in an A axis direction.

FIG. 11 is a view illustrating a force acting on the hook stop portion of the second group holding frame in a B axis direction.

FIG. 12 is a view illustrating a force acting on the second group holding frame in a rotational direction.

FIG. 13 is a view illustrating a force acting on the second group holding frame in a Y axis direction.

FIG. 14 is a view illustrating a force acting on the second group holding frame in an A axis direction.

FIG. 15 is a view illustrating a force acting on the second group holding frame in a B axis direction.

### DESCRIPTION OF THE EMBODIMENTS

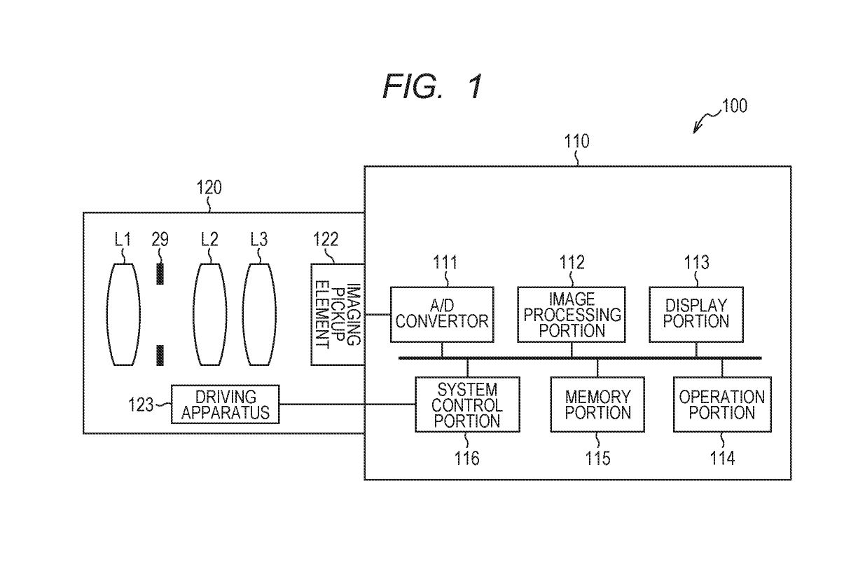

An embodiment of the present invention will now be described below in detail in accordance with the accompanying drawings. It is noted that only parts necessary for explanation of the embodiment are illustrated in a simplified manner as required in respective drawings for illustrative and explanatory convenience. FIG. 1 is a view illustrating an example of a general configuration of an image pickup apparatus.

In FIG. 1, an image pickup apparatus 100 is provided with a camera main body 110 and a lens barrel 120. The lens barrel 120 may be configured to be mounted on the camera main body 110 or to be integrated with the camera main body 110.

The lens barrel 120 is provided with an image pickup lens optical system including a first group lens L1, a second group lens L2, a third group lens L3 and a fixed aperture 29. Further, in the embodiment, an image pickup element 122 is mounted on the lens barrel 120.

Furthermore, the lens barrel 120 is provided with a driving apparatus 123. The driving apparatus 123 is configured to drive each element of the lens barrel 120. For example, the driving apparatus 123 calculates a movement amount and a movement direction of the second group lens L2 on the basis of information from a sensor that detects shake (vibration) of the image pickup apparatus 100 and information from a sensor that detects a position of the second group lens L2 functioning as a vibration proof lens. Then, an image blur correction apparatus to be described below drives the second group lens L2 according to results calculated by the driving apparatus 123.

The camera main body 110 is provided with an A/D convertor 111, an image processing portion 112, a display portion 113, an operation portion 114, a memory portion 115 and a system control portion 116.

An image of an object is imaged on an image pickup element 122 through an image pickup lens optical system. The image pickup element 122 converts an image (optical signal) of the imaged object into an analogue electric signal. The A/D convertor 111 converts the analogue electric signal output from the image pickup element 122 into a digital electric signal (image signal). The image processing portion 112 performs various image processing to the digital electric signal (image signal) output from the A/D convertor 111.

The display portion 113 displays various information. For example, the display portion 113 may be constituted by using an electronic viewfinder and a liquid crystal panel. The operation portion 114 functions as a user interface for enabling a user to issue instructions to the image pickup apparatus 100. It is noted that if the display portion 113 is provided with a touch panel, the touch panel also constitutes a part of the operation portion 114.

The memory portion 115 stores various data such as image data and the like to which image processing is performed by the image processing portion 112. Further, the memory position 115 also stores a program. For example, the memory portion 115 may be constituted by using a ROM, a RAM and an HDD.

The system control portion 116 integrally controls the whole image pickup apparatus 100. For example, the system control portion 116 may be constituted by using a CPU.

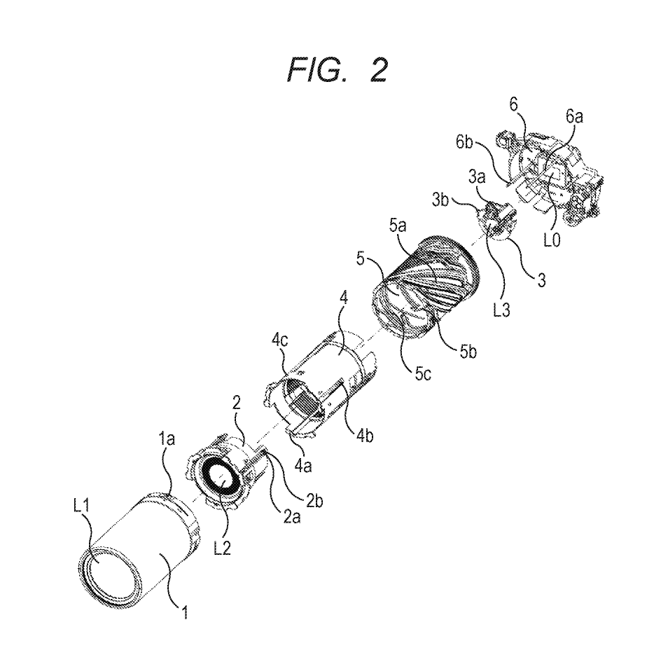

FIG. 2 is an exploded perspective view illustrating an example of a configuration of the lens barrel 120.

First, while referring to FIG. 2, the configuration of the lens barrel 120 of the embodiment will be explained.

A first group barrel 1 is configured to hold a first group lens L1. Three cam pins 1a arranged at a lower position of an inner circumferential surface of the first group barrel 1 are engaged with a cam groove 5a formed at an outer circumferential surface of a cam barrel 5. Further, linear movement grooves not illustrated are formed at three places of the inner circumferential surface of the first group barrel 1. Those linear movement grooves are engaged with a linear movement key 4a formed at an upper end of the outer circumferential surface of the linear movement barrel 4.

A second group barrel 2 is configured to hold a second group lens L2. Three cam pins 2a arranged at a lower portion of an outer circumferential surface of the second group barrel 2 are engaged with a cam groove 5b formed at an inner circumferential surface of the cam barrel 5. Further, in the second group barrel 2, linear movement keys 2b are formed at the same places as the cam pins 2a. The linear movement keys 2b are engaged with a linear movement groove 4b formed in the linear movement barrel 4.

A cam groove 5c formed at an upper portion of the inner circumferential surface of the cam barrel 5 is engaged with three cam pins 4c arranged at an upper portion of the outer circumferential surface of the linear movement barrel 4.

The first group barrel 1 and the second group barrel 2 are unrotationally supported by the linear movement barrel 4. When the cam barrel 5 is rotated by the driving apparatus 123, the cam barrel 5 moves in an optical axis direction while rotating by action between the cam groove 5c of the cam barrel 5 and the cam pins 4c of the linear movement barrel 4.

The first group barrel 1 moves in the optical axis direction without rotation by action between the cam pins 1a of the first group barrel 1 and the cam groove 5a of the cam barrel 5 and by action between the linear movement groove of the first group barrel 1 and the linear movement key 4a of the linear movement barrel 4.

The second group barrel 2 moves in the optical axis direction without rotation by action between the cam pins 2a of the second group barrel 2 and the cam groove 5b of the cam barrel 5 and by action between the linear movement groove 2b of the second group barrel 2 and the linear movement key 4b of the linear movement barrel 4.

A third group holding frame 3 is configured to hold a third group lens L3. A positioning portion 3a and a shake preventing portion 3b formed on the third group holding frame 3 are engaged with guide bars 6a and 6b arranged on a fixed base plate 6 to be supported movably in the optical direction. When the third group holding frame 3 is driven by the driving apparatus 123, the third holding frame 3 is moved in the optical axis direction without rotation by action between the positioning portion 3a and the shake preventing portion 3b and the guide bars 6a and 6b.

The image pickup element 122 (see FIG. 1) and an optical filter L0 are held by the fixed base plate 6. Further, the linear movement barrel 4 is fixed to the fixed base plate 6 by a screw not illustrated.

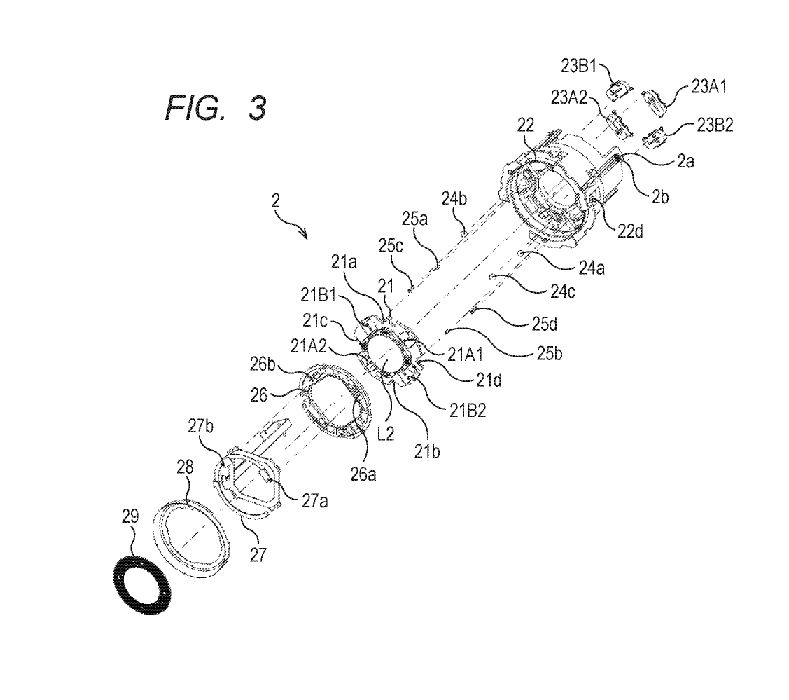

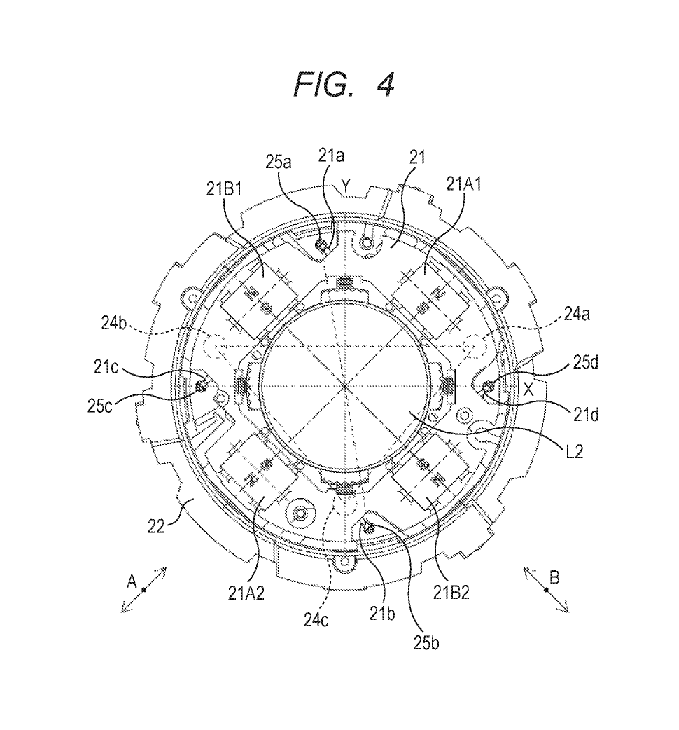

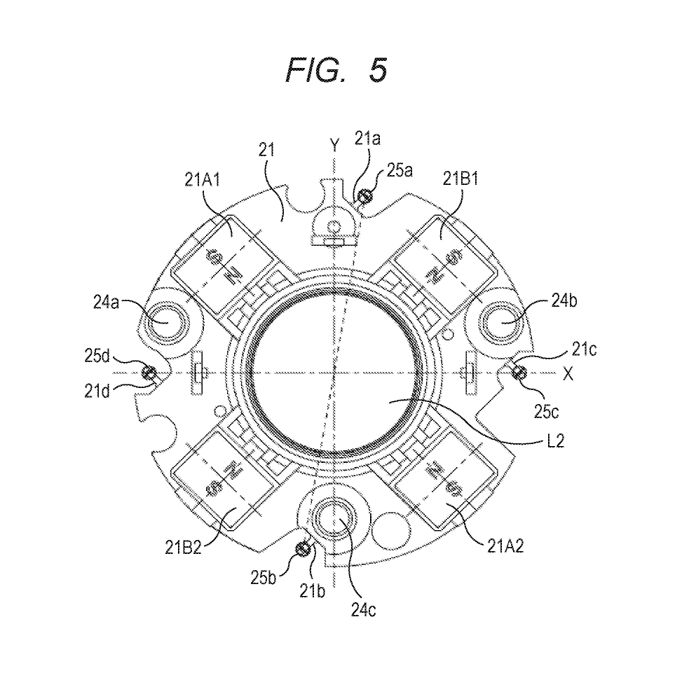

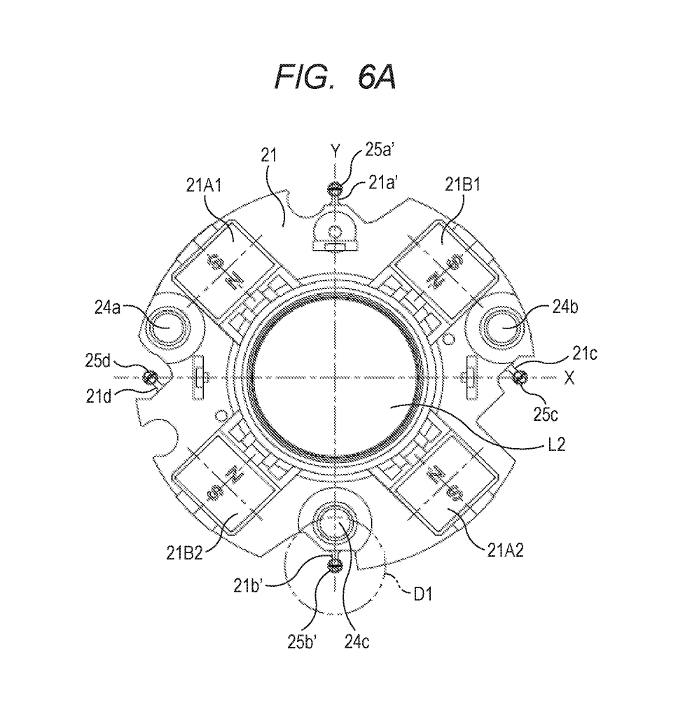

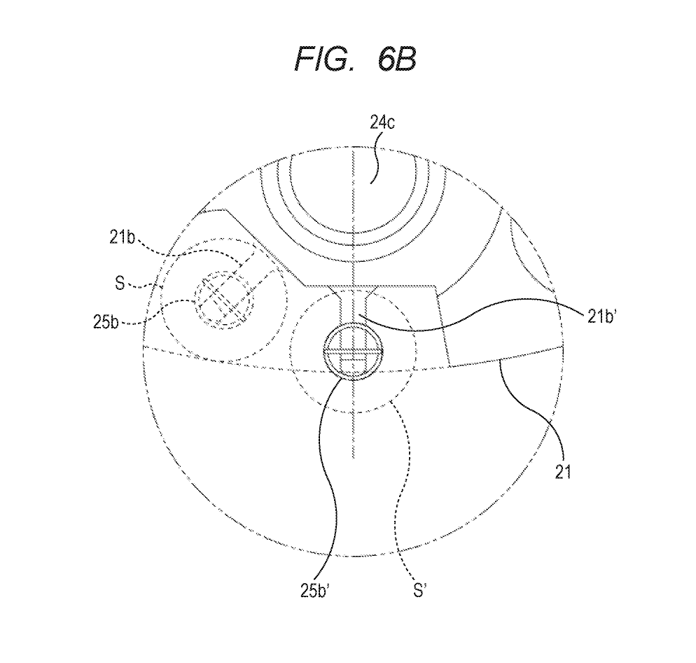

FIG. 3 is an exploded perspective view illustrating an example of a configuration of the second group barrel 2. FIG. 4 is a front view illustrating the configuration of the second group barrel 2 illustrated in FIG. 3. FIG. 5 is a rear view illustrating the configuration of the second group barrel 2 illustrated in FIG. 3. FIG. 6A is a view explaining an example of a positional relation between balls and springs of the second group barrel 2 and FIG. 6B is a partially enlarged view illustrating a portion D1 of FIG. 6A.

While referring to FIGS. 3, 4, 5, 6A and 6B, the example of the configuration of the second group barrel 2 will be explained. The second group barrel 2 functions as an image blur correction apparatus. In FIG. 3, the second group holding frame 21 holds the second group lens L2. It is noted that the second group lens will be referred to as a correction lens in the following explanation as necessary.

Magnets 21A1, 21A2, 21B1 and 21B2 are integrally held by the second group holding frame 21. It is noted that suffixes A and B attached to reference numerals correspond to an A axis direction and a B axis direction in FIG. 4. Here, the A axis direction indicates a first diction in which the second group holding frame 21 is driven and that extends in a plane orthogonal to the optical axis of the optical system excluding the second group lens L2. The B axis direction indicates a second direction in which the second group holding frame 21 is driven and that extends orthogonal to the A axis direction in the plane orthogonal to the optical axis of the optical system excluding the second group lens L2.

Further, hook stop portions 21a, 21b, 21c and 21d are provided one between each pair of two magnets adjacent to each other in an interval in a circumferential direction of the second group holding frame 21 as illustrated in FIG. 4. Springs 25a, 25b, 25c and 25d for applying a tensile force are hooked on the hook stop portions 21a, 21b, 21c and 21d. The plurality of springs 25a, 25b, 25c and 25d are arranged along an outer circumference of the second holding frame 21 as much as possible in consideration of assemblability. In the embodiment, the springs 25a, 25b, 25c and 25d are coiled springs, and hook portions by which the springs 25a, 25b, 25c and 25d are configured to be hooked on another member are formed at one ends and the other ends thereof.

The fixed aperture 29 is for eliminating harmful rays and fixed on the second group holding frame 21. Coil units 23A1, 23A2, 23B1 and 23B2 are provided with coils and bobbins. The coil units 23A1, 23A2, 23B1 and 23B2 are adhered to and fixed on dents of the second group base plate 22. Electricity is supplied to a metal pin that is embedded in the above-mentioned bobbins and that is electrically connected with the above-mentioned coils by a second group FPC 27 (flexible printed circuit) to be described below, so that electricity is supplied to the above-mentioned coils.

The other ends, hooked on the second group frame 21, of the four springs 25a, 25b, 25c and 25d are hooked on hook stop portions formed at the second group base plate 22. A single one of the hook stop portions is provided for each of the four springs 25a, 25b, 25c and 25d. In FIG. 3, only the hook stop portion 22d on which the other end of the spring 25d is hooked is illustrated among the four hook stop portions for illustrative convenience.

Three nonmagnetic balls 24a, 24b and 24c are sandwiched between the second group base plate 22 and the second group holding frame 21. The second holding frame 21 is in a pressed state toward the second group base plate 22 through the balls 24a, 24b and 24c. Since the second group holding frame 21 is pressed through the balls 24a, 24b and 24c, it is movable in a plane perpendicular to the optical axis. By moving the second group holding frame 21 in the plane, the correction lens L2 is movable relative to the second group base plate 22 in the plane. As a result, image blurring is suppressed on the image pickup element 122 and image blur correction is performed.

As described above, the second group holding frame 21 is a holding member for holding the second group lens L2 that is an example of the image blur correction lens, and the second group base plate 22 is a base plate member for the second barrel 2.

Further, the balls 24a, 24b and 24c are supporting members for supporting the second group holding frame 21 so that the second group holding frame 21 is movable relative to the second group base plate 22 in a plane orthogonal to the optical axis of the optical system excluding the correction lens L2.

Furthermore, the springs 25a, 25b, 25c and 25d, one ends of which are attached to the second group holding frame 21 and the other ends of which are attached to the second group base plate 22, are bias members for performing biasing in such a manner the balls 24a, 24b and 24c are sandwiched between the second group holding frame 21 and the second group base plate 22.

The second group FPC 27 is provided with lands with which the coil units 23A1, 23A2, 23B1 and 23B2 are electrically connected by solder. Further, two hole elements (not illustrated) that detect a magnetic field are mounted on a reverse side of the second group FPC 27.

Magnets 21A1, 21A2, 21B1 and 21B2 held by the second group holding frame 21 are magnetized in a direction shown in FIG. 4 (see N and S in FIG. 4). Movements in the A axis direction and the B axis direction of the second group holding frame 21 are detected as a change of magnetic field by each hole element. The driving apparatus 123 calculates a movement amount of the second group holding frame 21 (second group lens L2) in accordance with an amount of the change. Positional accuracies of the magnets 21A1 and 21B1 and the hole elements are important. Accordingly, the hole elements are pressed into the sensor support frame 26 to be positioned with high accuracy.

The second group FPC 27 is fixed by engagement between positioning holes 27a and 27b and positioning projections 26a and 26b of the sensor support frame 26. Further, the sensor support frame 26 is fixed on the second group base plate 22 by fixing a second group cover 28 on the second group base plate 22 with a bayonet structure not illustrated.

While referring to FIG. 4, stability of the second group holding frame 21 for holding the correction lens L2 with respect to the second group base plate 22 will be explained in the following.

The second group holding frame 21 is formed from a mold member and is provided with the correction lens L2 and the magnets 21A1, 21A2, 21B1 and 21B2, as mentioned above. Accordingly, a weight of the second group holding frame 21 is mainly controlled by a weight of the correction lens L2 and a weight of the magnets 21A1, 21A2, 21B1 and 21B2. At the start of drive for image blur correction, the second holding frame 21 is raised against the weight by a driving force of the magnets 21A1, 21A2, 21B1 and 21B2 and the coils 23A1, 23A2, 23B1 and 23B2. At this occasion, the second group holding frame 21 is raised in such a manner that a center of the correction lens L2 coincides with the optical axis of another image pickup lens optical system other than the correction lens L2.

FIG. 4 illustrates a state where the second group holding frame 21 is raised in such a manner that the center of the correction lens L2 coincides with the optical axis of another image pickup lens optical system other than the correction lens L2. The second group holding frame 21 is formed in a vertically and laterally symmetrical shape and the magnets 21A1, 21A2, 21B1 and 21B2 are also arranged vertically and laterally symmetrically. Accordingly, in the above mentioned state, the magnets 21A1, 21A2, 21B1 and 21B2 are mounted and the center of the second group holding frame 21 that holds the correction lens L2 is positioned the same as the optical axis.

Further, the three balls 24a, 24b and 24c are arranged in such manner that the gravity center of the second group holding frame 21 is included in a triangle formed by the three balls 24a, 24b and 24c that receive the second holding frame 21. Thereby, the second group holding frame 21 can be held stably. For example, if the three balls 24a, 24b and 24c are arranged in such a manner that the gravity center of the second group holding frame 21 is not included in the triangle formed by the three balls 24a, 24b and 24c, the second group holding frame 21 falls on a side of the gravity center of the second group holding frame 21. Thereby, the second group holding frame 21 becomes immovable in the plane orthogonal to the optical axis. It is noted that the three balls 24a, 24b and 24c are present in a reversed surface of the second group holding frame 21 so that the three balls 24a, 24b and 24c are illustrated in broken lines in FIG. 4.

As described above, the four springs 25a, 25b, 25c and 25d are hooked on the second group holding frame 21 between the second group holding frame 21 and the second group base plate 22 (see FIG. 3). In this state, axial directions of the four springs 25a, 25b, 25c and 25d are in parallel with the direction of the optical axis. As described above, the springs 25a, 25b, 25c and 25d are hooked in such a manner that the second group holding frame 21 and the second base plate 22 are pressed against each other, so that the three balls 24a, 24b and 24c are sandwiched by the second group holding frame 21 and the second group base plate 22.

In the embodiment, the second group holding frame 21 is formed in a vertically and laterally symmetrical shape, and the magnets 21A1, 21A2, 21B1 and 21B2 are also arranged vertically and laterally symmetrical. Accordingly, it is a condition for maintaining stability the most that a point where spring forces of the four springs 25a, 25b, 25c and 25d are combined is present inside the triangle formed by the three balls 24a, 24b and 24c, and the gravity center of the second group holding frame 21 is at the same position as the optical axis. Namely, the four springs 25a, 25b, 25c and 25d to be hooked on the second group holding frame 21 have a degree of freedom by which the springs may be hooked in any way with respect to the above mentioned triangle. To ensure the stability of the image blur correction apparatus, it is preferable to arrange the four springs 25a, 25b, 25c and 25d at positions equally distanced from the gravity center of the second group holding frame 21.

In the embodiment, the four springs 25a, 25b, 25c and 25d are arranged one between each pair of the magnets 21A1, 21A2, 21B1 and 21B2 arranged vertically and laterally symmetrically. Thereby, the second group holding frame 21 that holds the correction lens L2 is improved in stability.

Further, the two springs 25c and 25d positioned at right and left are arranged on the X axis line and the two springs 25a and 25b positioned at upper and lower positions are arranged slightly away from the Y axis line. As illustrated in FIG. 5, the ball 24c is arranged on the Y axis line in consideration of symmetry of the second group holding frame 21 and the magnets 21A1, 21A2, 21B1 and 21B2 mentioned above. As illustrated in FIG. 6A, if a spring 25b′ is arranged on a Y axis line, the spring 25b′, a drive range S′ of the spring 25b′ and a hook stop portion 21b′ extend outside beyond an outermost diameter portion of the second group holding frame 21 of the embodiment as illustrated in FIG. 6B.

In contrast, the spring 25b is arranged slightly away from the Y axis line in the embodiment. Namely, the spring 25b is arranged at a position away from a line segment formed by the gravity center of the second group holding frame 21 and (a center of) the ball 24c. With this configuration, the spring 25b, and a drive range S of the spring 25b and the hook stop portion 21b are arranged so as not to extend outside beyond the outermost diameter portion of the second group holding frame 21 of the embodiment. Thus, the second group holding frame 21 can be miniaturized.

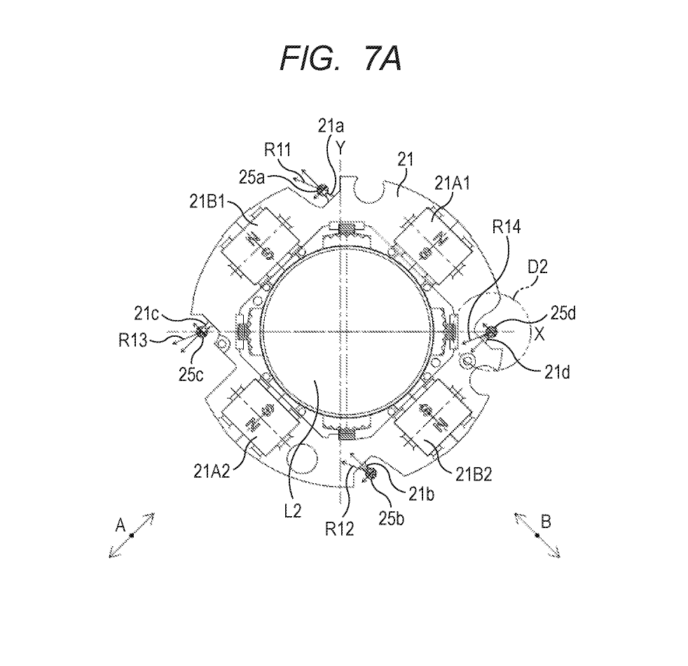

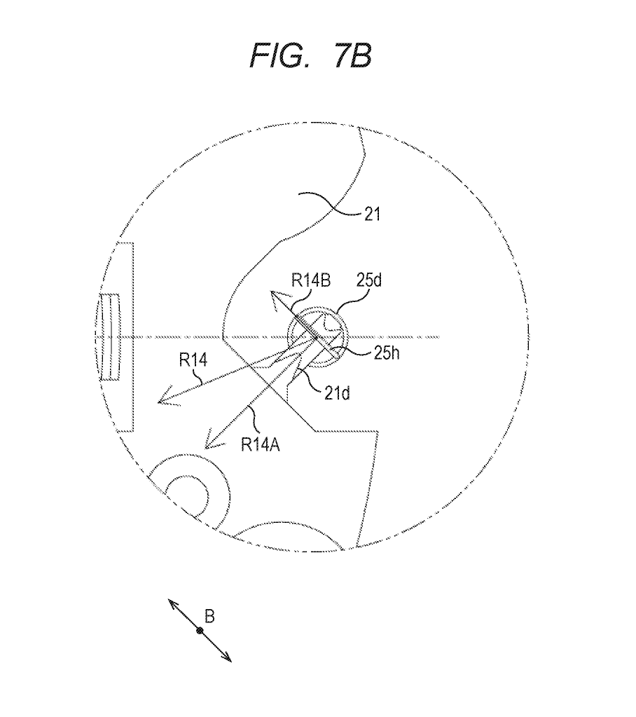

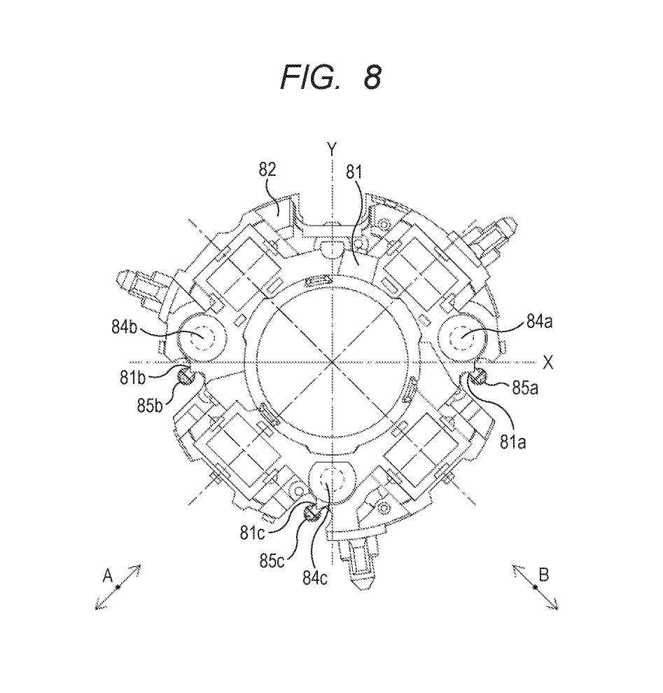

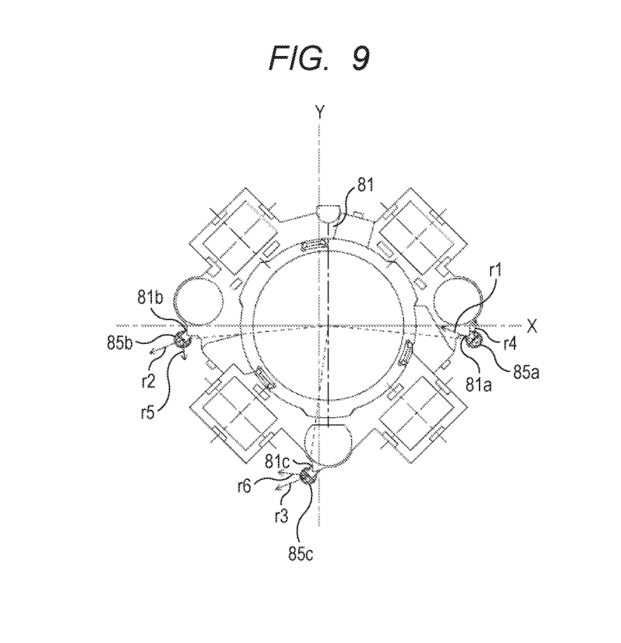

FIG. 7A is a view illustrating an example of a force acting on the second group holding frame 21 in an X axis direction. FIG. 7B is a partially enlarged view of a portion D2 of FIG. 7A. FIG. 8 is a front view illustrating a holding frame and a base plate of an image blur correction apparatus provided in a general image pickup apparatus (camera). Further, FIG. 9 is a view illustrating a force acting on the holding member illustrated in FIG. 8 in the X axis direction.

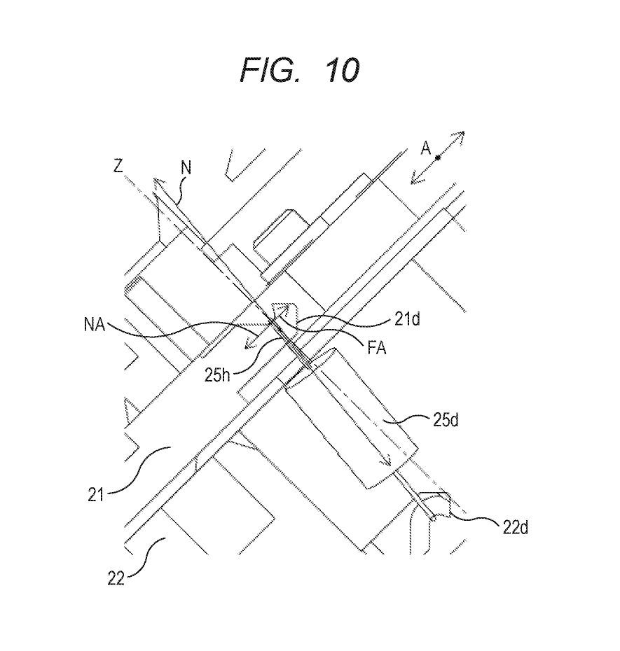

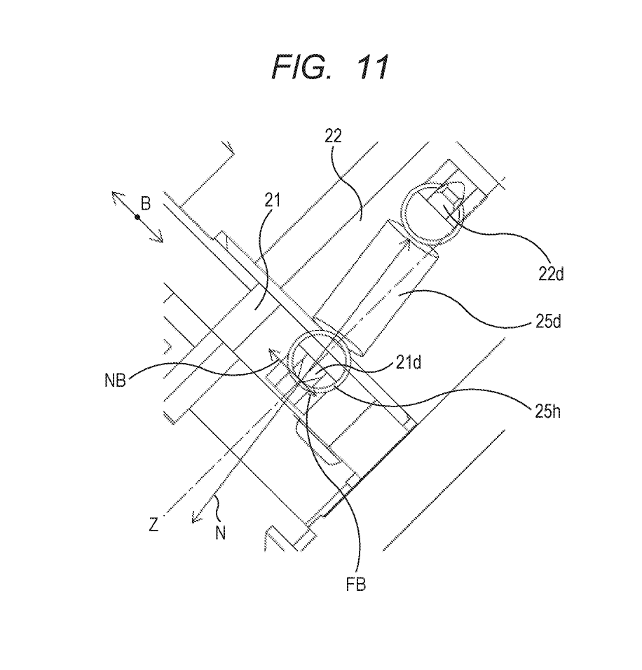

FIG. 10 is a view illustrating an example of a force acting on the hook stop portion 21d of the second group holding frame 21 in an A axis direction. FIG. 11 is a view illustrating a force acting on the hook stop portion 21d of the second group holding frame 21 in a B axis direction.

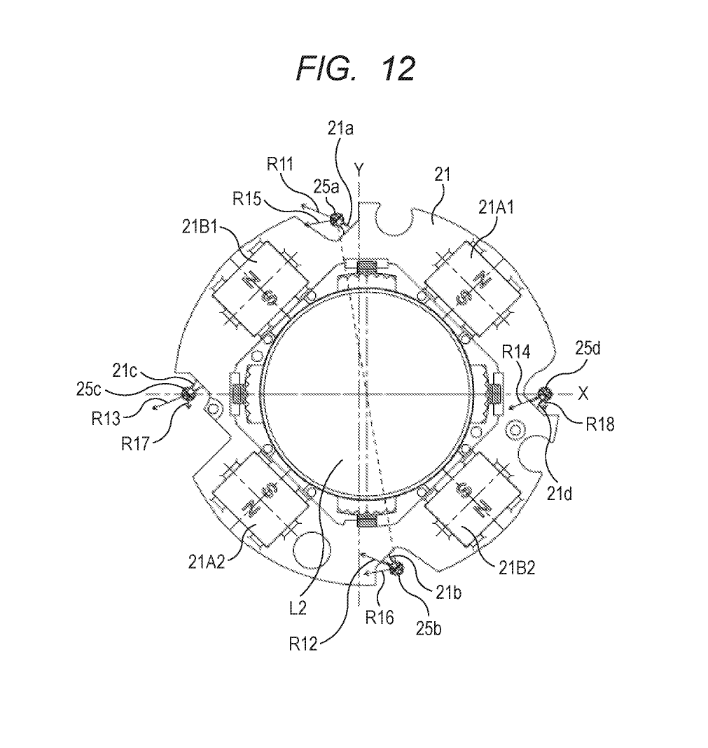

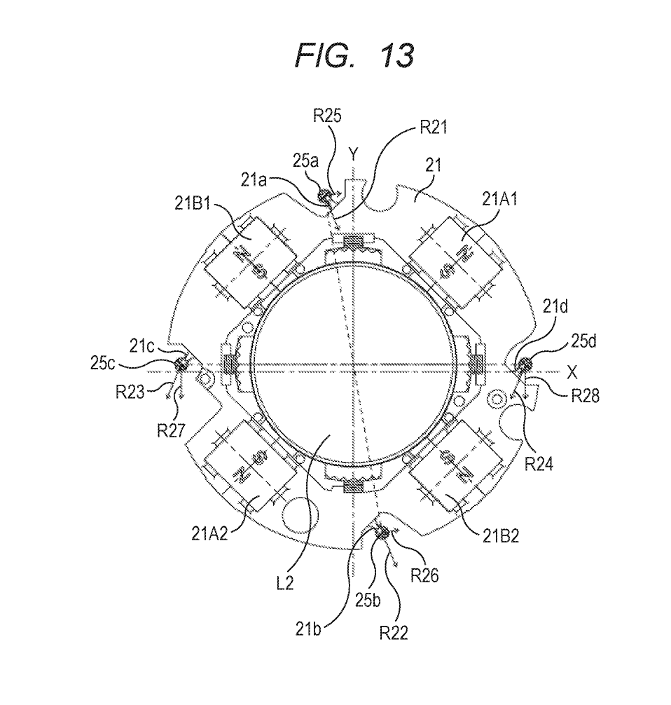

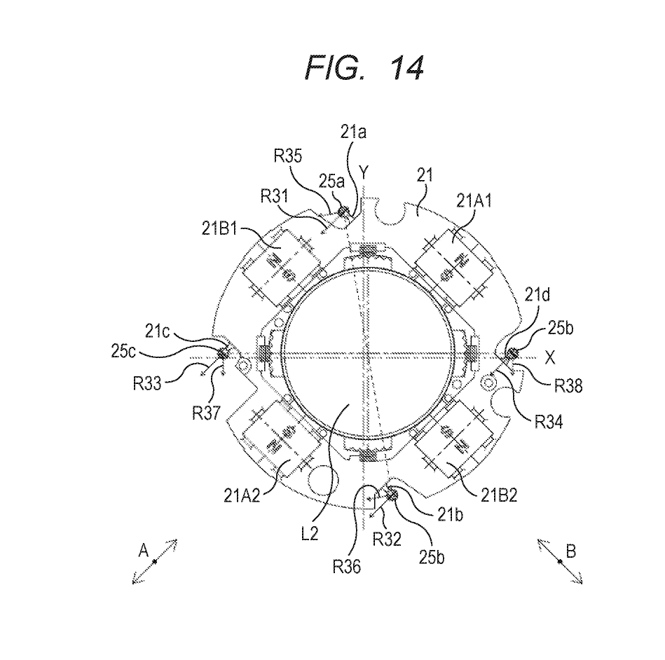

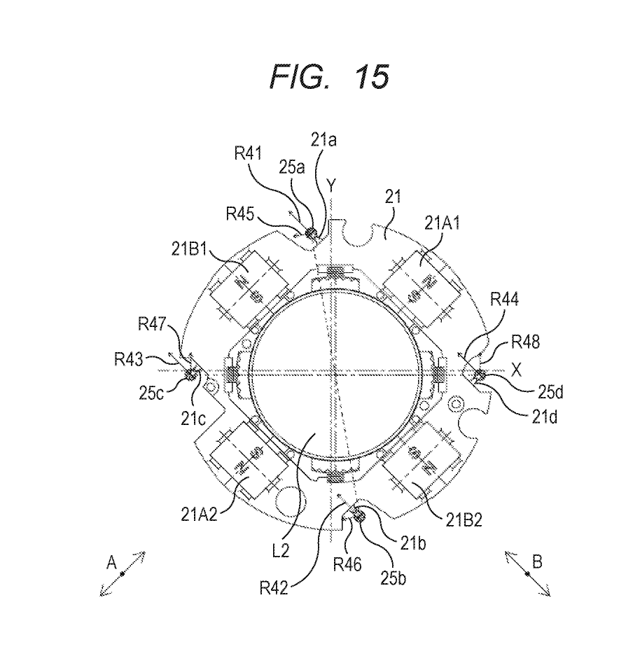

FIG. 12 is a view illustrating a force acting on the second group holding frame 21 in a rotational direction. FIG. 13 is a view illustrating a force acting on the second group holding frame 21 in a Y axis direction. FIG. 14 is a view illustrating a force acting on the second group holding frame 21 in an A axis direction. FIG. 15 is a view illustrating a force acting on the second group holding frame 21 in a B axis direction.

While referring to FIGS. 7A, 7B, 8, 9, 10, 11, 12, 13, 14 and 15, an example of a concrete hooking manner of the four springs 25a, 25b, 25c and 25d for preventing rolling will be described in comparison with a general hooking manner of springs.

The rolling means a force for causing rotation with respect to the gravity center of the second group holding frame 21 when a driving force for image blur correction is applied. In the embodiment, drive axises for image blur correction, extending from respective gravity centers of the magnets 21A1, 21A2, 21B1 and 21B2 pass through the gravity center of the second group holding frame 21. Accordingly, the second group holding frame 21 is prevented from being rotated by the driving force for image blur correction. However, since a reaction force against the driving force acts on the second group holding frame 21 depending on the hooking manner of the four springs 25a, 25b 25c and 25d, the second group holding frame 21 might happen to be rotated.

In the embodiment, the four springs 25a, 25b, 25c and 25d constitute two sets of two springs (springs 25a and 25b and springs 25c and 25d), each set having two springs arranged at positions to face to each other with the gravity center of the second group holding frame 21 interposed therebetween. Those two springs (springs 25a and 25b and springs 25c and 25d) are arranged at positions where the springs of each of the two sets are arranged point symmetrically with respect to the gravity center of the holding member. Further, the springs 25a and 25b are arranged in such a manner that a plane formed by an unillustrated hook portion constituting an end portion of the spring 25a and a plane formed by an unillustrated hook portion constituting an end portion of the spring 25b are arranged point symmetrically with respect to the gravity center of the second group holding member 21. Similarly, the springs 25c and 25d are arranged in such a manner that a plane formed by an unillustrated hook portion constituting an end portion of the spring 25c and a plane formed by a hook portion 25h constituting an end portion of the spring 25d are arranged point symmetrically with respect to the gravity center of the second group holding member 21.

For further details, each plane formed by the hook portions of one set of the two springs 25a and 25b among the springs 25a, 25b, 25c and 25d is in parallel with the A axis direction. Further, each plane formed by the hook portions of the other set of the two springs 25c and 25d among the springs 25a, 25b, 25c and 25d is in parallel with the B axis direction.

Thereby, influence of the rolling on the second group holding frame 21 can be lowered (the detail will be described below).

FIG. 8 is a view illustrating a state where the three springs 85a, 85b and 85c are hooked on a holding frame 81. Specifically, three balls 84a, 84b and 84c are arranged between a base plate 82 and the holding frame 81, and the three springs 85a, 85b and 85c are hooked on the base plate 82 and the hook stop portions 81a, 81b and 81c of the holding frame 81. Thereby, the holding frame 81 is movable on a plane orthogonal to an optical axis.

The two springs 85a and 85b arranged at right and left are arranged at positions where they are arranged laterally symmetrically with respect to a gravity center of the holding frame 81. The spring 85c is arranged at a central position close to a symmetrical axis line of the two springs 85a and 85b arranged at right and left. FIG. 9 illustrates a state that the holding frame 81 on which the three springs 85a, 85b and 85c are hooked is moved slightly along the X axis as described above. In FIG. 9, a state where the above mentioned rolling force by drive along the X axis acts on the gravity center of the holding frame 81 is illustrated.

In FIG. 9, counterforces r1, r2 and r3 against the driving force for image blur correction act on the holding frame 81 by the three springs 85a, 85b and 85c.

The two springs 85a and 85b arranged at right and left generate forces r4 and r5 for causing the holding frame 81 to rotate in a counterclockwise direction with respect to the gravity center of the holding frame 81. These forces r4 and r5 are component forces of the counterforces r1 and r2.

Further, the spring 85c arranged in the center generates a force r6 for causing the holding frame 81 to rotate in a clockwise direction with respect to the gravity center of the holding frame 81. The force r6 is a component force of the counterforce r3.

However, r4+r5>r6 or r4+r5<r6 is satisfied depending on the arrangement of the spring 85c arranged in the center. Thereby, rolling for causing the holding frame 81 to rotate counterclockwise or clockwise around the gravity center of the holding frame 81 occurs by the difference of forces.

Namely, in the configurations illustrated in FIGS. 8 and 9, a spring force acts in a direction for causing rolling to occur depending on the arrangement of the spring 85c arranged in the center. Accordingly, vibration control performance may be hindered.

FIG. 7A illustrate a state where the second group holding frame 21 of the embodiment is slightly moved in a right direction along an X axis in FIG. 7A, similarly to FIG. 9.

In a case where a driving force acts for image blur correction, the second group holding frame 21 receives counterforce R11, R12, R13 and R14 against the driving force from the four springs 25a, 25b, 25c and 25d. Accordingly, the hook stop portions 21a, 21b, 21c and 21d of the second group holding frame 21 receive the counterforces R11, R12, R13 and R14. Magnitudes of the counterforces R11, R12, R13 and R14 vary depending on how the hook portions of the springs 25a, 25b, 25c and 25d are hooked on the hook stop portions 21a, 21b, 21c and 21d.

It is noted that although FIG. 7B illustrates only a hook portion 25h of the spring 25d, hook portions of the other springs 25a, 25b and 25c are also configured the same as the hook portion 25h of the spring 25d. In the embodiment, the hook portion 25h is formed in a ring shape (see FIG. 11). It is noted that the hook portion is not limited to the ring shape and, for example, may adopt a circular arc shape, a V-shape or a U-shape.

FIG. 7B is an enlarged view illustrating the hook stop portion 21d at the right side of the second group holding frame 21 and the vicinity thereof (portion D2) illustrated in FIG. 7A.

The hook stop portion 21a is shaped in such a manner that a plane formed by a hook portion of the spring 25a is in parallel with the A axis direction that is a drive direction for image blur correction. The hook stop portion 21b is also shaped in such a manner that a plane formed by a hook portion of the spring 25b is in parallel with the A axis direction that is a drive direction for image blur correction.

On the other hand, the hook stop portion 21c is shaped in such a manner that a plane formed by a hook portion of the spring 25c is in parallel with the B axis direction that is a drive direction for image blur correction. The hook stop portion 21d is also shaped in such a manner that a plane formed by a hook portion 25h of the spring 25d is in parallel with the B axis direction that is a drive direction for image blur correction.

It is noted that the plane formed by the hook portion 25h of the spring 25d is a plane formed by a ring shaped area of the hook portion 25h. As illustrated in FIG. 11, a shape of the plane formed by the ring shaped area of the hook portion 25h is circular. Further, as illustrated in FIG. 7B, the plane formed by the ring shaped area of the hook portion 25h is a plane parallel with the B axis direction. This is also the same with the hook portions of the other springs 25a, 25b and 25c. It is noted that the planes formed by the ring shaped areas of the hook portions of the springs 25a and 25b are planes parallel with the A axis direction.

Accordingly, friction forces of the hook portions of the springs 25a, 25b, 25c and 25d on the hook stop portions 21a, 21b, 21c and 21d of the second group holding frame 21 are varied between the A axis direction and in the B axis direction. The hook portion 25h of the spring 25d is positioned at the lowermost point of a groove of the hook stop portion 21d of the second group holding frame 21 by a spring force. Accordingly, if the second group holding frame 21 is displaced in the A axis direction, the hook portion 25h rolls at the lowermost point to absorb such displacement.

Further, when the second group holding frame 21 is displaced in the B axis direction, the hook portion 25h is changed within the degree of freedom based on its shape while a contact portion of the hook portion with the hook stop portion 21d always rubs against the hook stop portion 21d. A radius (rolling radius) of a line of the hook portion 25h is smaller than a radius of the ring (circular) of the hook portion 25h.

Accordingly, the friction force of the former is made smaller than that of the latter. In the A axis direction, a resultant force R14A of a component force NA of the spring 25d and a fiction force FA (normal force N×coefficient of friction MA) in the A axis direction acts on the hook stop portion 21d (see FIGS. 7B and 10). In contrast, with respect to the B axis direction, a resultant force R14B of a component force NB of the spring 25d and a fiction force FB (normal force N×coefficient of friction MB) in the B axis direction acts on the hook stop portion 21d (see FIGS. 7B and 11).

Therefore, in FIG. 7A, a counterforce is a resultant force R14 obtained from a combination of a force in the A axis direction and a force in the B axis direction. Accordingly, a force for causing the second group holding frame 21 to rotate with respect to the gravity center of the second group holding frame 21 is represented as a component force R18 as illustrated in FIG. 12.

It is noted that here the case where the hook portion 25h of the spring 25d is hooked on the hook stop portion 21d has been exemplified and described thus far. However, in cases where the springs 25a, 25b and 25c are hooked on the hook stop portions, resultant forces R11, R12 and R13 and component forces R15, R16 and R17 in the rotational direction are also represented (see FIG. 12), similarly to the case where the hook portion 25h of the spring 25d is hooked on the hook stop portion 21d.

Further, in the embodiment, the springs 25a and 25b are arranged point symmetrically with respect to the gravity center of the second group holding frame 21. Furthermore, a plane formed by the hook portion constituting one end portion of the spring 25a and a plane formed by the hook portion constituting one end portion of the spring 25b are arranged so as to be point symmetrical with respect to the gravity center of the second group holding frame 21. Thereby, the component forces R15 and R16 received by the hook stop portions 21a and 21b in the rotational direction are made equal. Similarly, the springs 25c and 25d are arranged so as to be point symmetrical with respect to the gravity center of the second group holding frame 21. Additionally, a plane formed by the hook portion constituting one end portion of the spring 25c and a plane formed by the hook portion 25h constituting one end portion of the spring 25d are arranged so as to be point symmetrical with respect to the gravity center of the second group holding frame 21. Thereby, the component forces R17 and R18 received by the hook stop portions 21c and 21d in the rotational direction are made equal.

In this case, directions of the component forces R15 and R16 to be received by the hook stop portions 21a and 21b in the rotational direction are directions offsetting each other. Further, directions of the component forces R17 and R18 to be received by the hook stop portions 21c and 21d in the rotational direction are also directions offsetting each other.

Accordingly, forces act in a direction for offsetting rolling by the springs 25a, 25b, 25c and 25d that are hooked in the above mentioned manner.

Practically, directions and magnitudes of the component forces R15, R16, R17 and R18 are varied depending on how the springs 25a, 25b, 25c and 25d are hooked. However, the fact remains that the component forces R15 and R16 to be received by the hook stop portions 21a and 21b in the rotational direction offset each other, and the component forces R17 and R18 to be received by the hook stop portions 21c and 21d in the rotational direction offset each other. Thus, the details of the springs 25a, 25b, 25c and 25d hooked in another manner are omitted from the description.

Further, here the case where the second group holding frame 21 is moved to the one side (right side of FIG. 12) in the X axis direction has been exemplified and described as drive for image blur correction. Since the second group holding frame 21 is formed in the vertically and laterally symmetrical shape, even in a case where the second group holding frame 21 is moved to the other side in the X axis direction (left side of FIG. 12), the second group holding frame 21 generates no rolling, similarly in the case where the second group holding frame 21 is moved to the one side in the X axis direction (right side of FIG. 12).

FIG. 13 is illustrates a state where the second group holding frame 21 is slightly moved upward along the Y axis in the figure by drive for image blur correction. In a case where a driving force is applied for image blur correction, the second group holding frame 21 receives the counterforces R21, R22, R23 and R24 against the driving force from the four springs 25a, 25b, 25c and 25d. In this case, directions of component forces R25 and R26 to be received by the hook stop portions 21a and 21b of the springs 25a and 25b are directions offsetting each other. Further, directions of component forces R27 and R28 to be received by the hook stop portions 21c and 21d of the springs 25c and 25d are also directions offsetting each other. Accordingly, the second group holding frame 21 generates no rolling.

Here, the case where the second group holding frame 21 is moved to the one side (upper side of FIG. 13) in the Y axis direction has been exemplified and described as drive for image blur correction. The second group holding frame 21 is formed in the vertically and laterally symmetrical shape. Accordingly, even in a case where the second group holding frame 21 is moved to the other side in the Y axis direction (lower side of FIG. 13), the second group holding frame 21 generates no rolling, similarly to the case where the second group holding frame 21 is moved to the one side in the X axis direction (upper side of FIG. 13).

FIG. 14 illustrates a state where the second group holding frame 21 is slightly moved obliquely upward to the right along the A axis in the figure, by drive for image blur correction.

In a case where driving force is applied for image blur correction, the second group holding frame 21 receives the counterforces R31, R32, R33 and R34 against the driving force from the four springs 25a, 25b, 25c and 25d.

Planes formed by the hook portions 25 of the springs 25a and 25b are in parallel with the drive direction of the second group holding frame 21. Accordingly, no friction force or component force in a direction orthogonal to the planes formed by the hook portions 25h of the springs 25a and 25b is applied to the counterforces R31 and R32 to be received by the hook stop portions 21a and 21b. Similarly, planes formed by the hook portions of the springs 25c and 25d are orthogonal to the drive direction of the second group holding frame 21. Accordingly, no friction force or component force in a direction parallel with the planes formed by the hook portions of the springs 25c and 25d is applied to the counterforces R33 and R34 to be received by the hook stop portions 21c and 21d.

In this case, directions of component forces R35 and R36 to be received by the hook stop portions 21a and 21b are directions offsetting each other. Directions of component forces R37 and R38 to be received by the hook stop portions 21c and 21d are also directions offsetting each other. Accordingly, the second group holding frame 21 generates no rolling in this case.

Here, the case where the second group holding frame 21 is moved to the one side (obliquely upward to the right of FIG. 14) in the A axis direction has been exemplified and described as drive for image blur correction. The second group holding frame 21 is formed in the vertically and laterally symmetrical shape. Accordingly, even in a case where the second group holding frame 21 is moved to the other side in the A axis direction (obliquely downward to the left direction of FIG. 14), the second group holding frame 21 generates no rolling, similarly to the case where the second group holding frame 21 is moved to the one side in the A axis direction (obliquely upward to the right direction of FIG. 14).

FIG. 15 illustrates a state where the second group holding frame 21 is slightly moved obliquely downward to the right along the B axis in the figure by drive for image blur correction.

In a case where a driving force is applied for image blur correction, the second group holding frame 21 receives the counterforces R41, R42, R43 and R44 against the driving forces from the four springs 25a, 25b, 25c and 25d.

Planes formed by the hook portions of the springs 25a and 25b are orthogonal to the drive direction of the second group holding frame 21. Accordingly, no friction force or component force in a direction parallel with the planes formed by the hook portions 25h of the springs 25a and 25b acts on counterforces R41 and R42 to be received by the hook stop portions 21a and 21b.

Similarly, planes formed by the hook portions of the springs 25c and 25d are in parallel with the drive direction of the second group holding frame 21. Accordingly, no friction force or component force in a direction orthogonal to the planes formed by the hook portions 25h of the springs 25c and 25d acts on counterforces R43 and R44 to be received by the hook stop portions 21c and 21d.

In this case, directions of component forces R45 and R46 to be received by the hook stop portions 21a and 21b are directions offsetting each other. Directions of component forces R47 and R48 to be received by the hook stop portions 21c and 21d are also directions offsetting each other. Accordingly, the second group holding frame 21 generates no rolling in this case.

Here, the case where the second group holding frame 21 is moved to the one side (obliquely downward to the right of FIG. 15) in the B axis direction has been exemplified and described as drive for image blur correction. The second group holding frame 21 is formed in the vertically and laterally symmetrical shape. Accordingly, even in a case where the second group holding frame 21 is moved to the other side in the B axis direction (obliquely upward to the left direction of FIG. 15), the second group holding frame 21 generates no rolling, similarly to the case where the second group holding frame 21 is moved to the one side in the B axis direction (obliquely downward to the right direction of FIG. 15).

As described above, in the cases where the second holding frame 21 is driven in the X axis direction, the Y axis direction, the A axis direction and the B axis direction in an XY plane, spring forces act in directions offsetting the rolling in any case.

Further, if the second group holding frame 21 is moved in a drive direction other than those directions, since the drive is represented by either combination of those drives, this fact remains that spring forces act in directions offsetting the rolling in any case.

As above, in the image blur correction apparatus of the embodiment, the four springs 25a, 25b, 25c and 25d are arranged one between each pair of two springs of the magnets 21A1, 21A2, 21B1 and 21B2 arranged vertically and laterally symmetrically, thereby improving stability of the second group holding frame 21 for holding the correction lens L2.

Further, the two springs (springs 25a and 25b, and springs 25c and 25d) facing to each other with the gravity center of the second group holding frame 21 interposed therebetween are arranged point symmetrically with respect to the gravity center of the second group holding frame 21. Furthermore, the springs 25a and 25b are arranged in such a manner that the plane formed by the hook portion constituting an end portion of the spring 25a and the plane formed by the hook portion constituting an end portion of the spring 25b are arranged point symmetrically with respect to the gravity center of the second group holding member 21. Similarly, the springs 25c and 25d are arranged in such a manner that the plane formed by the hook portion constituting an end portion of the spring 25c and the plane formed by the hook portion 25h constituting an end portion of the spring 25d are arranged point symmetrically with respect to the gravity center of the second group holding member 21. As configured above, rolling influencing on the second group holding frame 21 can be reduced.

While one embodiment of the present invention has been described, it is to be understood that the scope of the invention is not limited to what has been described in the embodiment and various change or modification may be made within the gist of the invention.

For example, in the embodiment, the configuration that the magnets 21A1, 21A2, 21B1 and 21B2 are mounted on the second group holding frame 21 has been exemplified and described. However, as long as the component elements of the actuator for driving the second group holding frame 21 by an electric magnetic force and so on are mounted on the second group holding frame 21, what is mounted on the second group holding frame 21 is not limited to the magnets 21A1, 21A2, 21B1 and 21B2. For example, the coil units 23A1, 23A2, 23B1 and 23B2 may be configured to be mounted on the second group holding frame 21. In the configuration, the magnets 21A1, 21A2, 21B1 and 21B2 are mounted on the second group base plate 22. Regarding the gravity center, a gravity center of the second group holding frame 21 on which the coil units 23A1, 23A2, 23B1 and 23B2 are mounted and that holds the correction lens L2 should be considered.

Further, the case where the number of the component elements (magnets 21A1, 21A2, 21B1 and 21B2) of the actuator to be mounted on the second group holding frame 21 is four has been exemplified and described in the embodiment. However, the number of the component elements to be mounted on the second group holding frame 21 is not particularly limited. For example, the number of the component elements of the actuator to be mounted on the second group holding frame 21 may be an even number (preferably not less than four). In this case, for example, springs are arranged one between the component elements of the actuator mounted on the second group holding frame 21. It is noted that, for example, in a case where an even number of magnets are mounted on the second group holding frame 21, a same number of coil units as the magnets are mounted on the second base plate 22 at positions corresponding to the respective magnets.

Furthermore, the case where the springs 25a, 25b, 25c and 25d are arranged one between the magnets 21A1, 21A2, 2181 and 21B2 has been exemplified and described in the embodiment. However, at least one spring suffices to be arranged between the magnets 21A1, 21A2, 21B1 and 21B2. For example, the number of springs arranged in two regions may be the same, each of the two regions being between adjacent two magnets (for example, magnets 21A1 and 21B1) in a circumferential direction of the second group holding frame 21 and the two regions facing to each other through the gravity center of the second group holding frame 21. In this case, the number of the springs arranged in one pair of two regions may be differentiated from that in the other pair of the two regions, each of the two regions being between adjacent two magnets in the circumferential direction of the second group holding frame 21 and the two regions facing to each other through the gravity center of the second group holding frame 21, or the number of the springs may be the same in all the regions.

Additionally, the hook stop portions 21a and 21b are shaped in such a manner that the plane formed by the hook portion of the spring 25a and the plane formed by the hook portion of the spring 25b are in parallel with the A axis direction that is the drive direction for image blur correction in the embodiment. Similarly, the hook stop portions 21c and 21d are shaped in such a manner that the plane formed by the hook portion of the spring 25c and the plane formed by the hook portion 25h of the spring 25d are in parallel with the B axis direction that is the drive direction for image blur correction in the embodiment. However, it is not necessarily to have the above configuration. Namely, a plane formed by each hook portion may be configured to be unparallel with the drive direction for image blur correction.

Further, the case where an image blur correction apparatus is applied to an image pickup apparatus (camera) has been exemplified and described in the embodiment. However, the image blur correction apparatus may be also applied to an optical apparatuses such as mobile phones, binocular telescopes and the like having an image pickup function capable of image blur correction.

### Another Embodiment

The processing performed by the driving apparatus 123 upon driving the second group holding frame 21 and the like can be also executed by the following processing. Namely, first, software (computer program) is supplied to systems or apparatuses through a network or various storage media. Then, a computer (a CPU, an MPU or the like) of the systems or the apparatuses reads out and executes the computer program.

According to the invention, a lens for performing image blur correction can be held stably.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-260451, filed Dec. 24, 2014, which is hereby incorporated by reference herein in its entirety.

What is claimed is:

1. An image blur correction apparatus comprising:
a base plate member;
a holding member that holds an image blur correction lens;
an even number of actuator constituting members mounted on the holding member for moving the holding member;
a support member arranged to support the holding member in such a manner that the holding member is movable relative to the base plate member; and
a plurality of bias members, one end and the other end thereof being respectively mounted on the holding member and the base plate member, the bias members performing biasing in such a manner that the support member is sandwiched by the base plate member and the holding member,
wherein at least one of the bias members is arranged in a region between two of the actuator constituting members adjacent to each other in the circumferential direction of the holding member, and
wherein the bias members arranged in two regions each between two of the actuator constituting members adjacent to each other in the circumferential direction are the same in number, the two regions opposing each other through a gravity center of the holding member.

2. An image blur correction apparatus according to claim 1, wherein the bias members are arranged one in a region between two of the actuator constituting members adjacent to each other.

3. An image blur correction apparatus comprising:
a base plate member;
a holding member that holds an image blur correction lens;
an actuator constituting member mounted on the holding member for moving the holding member;
a support member arranged to support the holding member in such a manner that the holding member is movable relative to the base plate member; and
an even number of bias members, one end and the other end thereof being respectively mounted on the holding member and the base plate member, the bias members performing biasing in such a manner that the support member is sandwiched by the base plate member and the holding member,
wherein any one of the even number of bias members is arranged in such a manner that one of the bias members and another one of the bias members different from the one of the bias members are positioned in opposition to each other through a gravity center of the holding member.

4. An image blur correction apparatus according to claim 1,
wherein the support member includes three balls,
wherein the actuator constituting members include four magnets or four coil units each including a coil, and
wherein the bias members include four springs.

5. An image blur correction apparatus according to claim 4,
wherein when the holding member is positioned at a position where a center of the image blur correction lens is aligned with the optical axis, a point where spring forces of the four springs are combined is positioned inside a triangle formed by the three balls.

6. An image blur correction apparatus according to claim 5,
wherein the four springs are arranged outside the triangle.

7. An image blur correction apparatus according to claim 5,
wherein the four magnets are arranged symmetrically with respect to a gravity center of the holding member.

8. An image blur correction apparatus according to claim 4,
wherein the four springs are constituted by two pairs each including two springs arranged in positions to face to each other with a gravity center of the holding member interposed therebetween, and
wherein the two springs of each of the two pairs are arranged point symmetrically with respect to the gravity center of the holding member.

9. An image blur correction apparatus according to claim 8,
wherein one ends of the four springs are provided with hook portions to be hooked on the holding member, and
wherein planes formed by the hook portions of the two springs of each of the two pairs are arranged at point symmetry positions with respect to the gravity center of the holding member.

10. An image blur correction apparatus according to claim 9,
wherein the holding member is movable in either one of a first direction in the plane and a second direction orthogonal to the first direction in the plane, and
wherein planes formed by the hook portions of the two springs of one of the two pairs are arranged in parallel with the first direction and planes formed by the hook portions of two springs of the other of the two pairs are arranged in parallel with the second direction.

11. An image blur correction apparatus according to claim 4,
wherein at least one spring of the four springs is arranged at a position away from a line segment formed in the plane by the gravity center of the holding member and one ball of the three balls.

12. An image pickup apparatus comprising an image blur correction apparatus, said image blur correction apparatus including:
a base plate member;
a holding member that holds an image blur correction lens;
an even number of actuator constituting members mounted on the holding member for moving the holding member;
a support member arranged to support the holding member in such a manner that the holding member is movable relative to the base plate member; and
a plurality of bias members, one end and the other end thereof being respectively mounted on the holding member and the base plate member, the bias members performing biasing in such a manner that the support member is sandwiched by the base plate member and the holding member,
wherein at least one of the bias members is arranged in a region between two of the actuator constituting members adjacent to each other in the circumferential direction of the holding member, and
wherein the bias members arranged in two regions each between two of the actuator constituting members adjacent to each other in the circumferential direction are the same in number, the two regions opposing each other through a gravity center of the holding member.

13. An optical apparatus comprising an image blur correction apparatus, said image blur correction apparatus including:
a base plate member;
a holding member that holds an image blur correction lens;
an actuator constituting member mounted on the holding member for moving the holding member;
a support member arranged to support the holding member in such a manner that the holding member is movable relative to the base plate member; and
an even number of bias members, one end and the other end thereof being respectively mounted on the holding member and the base plate member, the bias members performing biasing in such a manner that the support member is sandwiched by the base plate member and the holding member,
wherein any one of the even number of bias members is arranged in such a manner that one of the bias members and another one of the bias members different from the one of the bias members are positioned in opposition to each other through a gravity center of the holding member.
